(19) United States
(12) Patent Application Publication
(10) Pub. No.: US 2026/0284980 A1
(43) Pub. Date: Sep. 24, 2026

(54) SYSTEMS FOR FORMING DENSIFIED STRUCTURES THROUGH SINTERING AND ASSOCIATED METHODS

(71) Applicant: Battelle Energy Alliance, LLC, Idaho Falls, ID (US)

(72) Inventors: Jorgen F. Rufner, Idaho Falls, ID (US); Stephanie A. Pitts, Idaho Falls, ID (US); Andrew J. Gorman, Rigby, ID (US); James F. Ford, Boise, ID (US); William C. Chuirazzi, Idaho Falls, ID (US); Arin S. Preston, Idaho Falls, ID (US); Michael J. Moorehead, Rigby, ID (US)

(21) Appl. No.: 19/571,238

(22) Filed: Mar. 18, 2026

Related U.S. Application Data
(60) Provisional application No. 63/774,586, filed on Mar. 19, 2025.

(51) Int. Cl. B29C 65/14; B29C 33/06; B29C 64/10; B29C 64/393; B33Y 10/00; B33Y 50/02; G06N 3/08

(52) U.S. Cl. CPC B29C 65/1403; B29C 33/06; B29C 64/10; B29C 64/393; B33Y 10/00; B33Y 50/02; G06N 3/08

(57) ABSTRACT

A system for forming a densified structure includes a processor and a memory device storing historical data representative of preform structures and densified structures. The system also includes non-transitory computer readable medium storing instructions thereon that, when executed by at the processor, cause the processor to perform steps including receiving parameters of a desired densified structure. The steps further include comparing the historical data representative of the preform structures and the densified structures with the parameters of the desired densified structure. The steps also include outputting parameters of a preform structure.

### CROSS-REFERENCE TO RELATED APPLICATIONS

This application claims the benefit under 35 U.S.C. § 119(e) of U.S. Provisional Patent Application Ser. No. 63/774,586, filed Mar. 19, 2025, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to manufacturing structures from advanced materials. More specifically, the disclosure is directed to sintering processes for complex structure manufacturing from advanced materials and associated methods.

### BACKGROUND

Advanced materials, such as ceramics, cermets, refractory materials, powder metallurgy metals and alloys, intermetallic materials, and composites play a crucial role in nearly all advanced technologies. For example, advanced materials may exhibit increased wear resistance, increased hardness, increased durability, and/or the ability to withstand harsh environments, such as high heat environments, corrosive environments, etc. Manufacturing parts from advanced materials is often difficult using conventional manufacturing methods. Sintering technologies, such as electric field assisted sintering (EFAS), hot isostatic pressing, hot pressing, etc., are typically used to manufacture structures from advanced materials.

### BRIEF SUMMARY

Embodiments of the disclosure include a method of forming a densified structure. The method includes forming a preform structure. The method further includes disposing the preform structure into a cavity of a mold. The method also includes disposing a pressure transfer material into the cavity of the mold around the preform structure. The method further includes applying a pressure to the cavity of the mold. The method also includes increasing a temperature in the cavity of the mold to a temperature above a sintering temperature of the preform structure and below a sintering temperature of the pressure transfer material until the preform structure becomes a densified structure. The method further includes removing the pressure transfer material from around the densified structure.

Another embodiment of the disclosure includes a system for forming a densified structure. The system includes a processor and a memory device storing historical data representative of preform structures and densified structures. The system also includes non-transitory computer readable medium storing instructions thereon that, when executed by at the processor, cause the processor to perform steps including receiving parameters of a desired densified structure. The steps further include comparing the historical data representative of the preform structures and the densified structures with the parameters of the desired densified structure. The steps also include outputting parameters of a preform structure.

Other embodiments of the disclosure include a method of forming a densified structure. The method includes receiving parameters of a desired densified structure. The method further includes comparing historical data representative of preform structures and densified structures with the parameters of the desired densified structure. The method also includes providing parameters of a preform structure. The method further includes forming, with an additive manufacturing device, the preform structure according to the parameters of the preform structure. The method also includes forming, with a sintering assembly, the desired densified structure from the preform structure.

### BRIEF DESCRIPTION OF THE DRAWINGS

While the specification concludes with claims particularly pointing out and distinctly claiming embodiments of the disclosure, the advantages of embodiments of the disclosure may be more readily ascertained from the following description of embodiments of the disclosure when read in conjunction with the accompanying drawings in which:

FIG. 1 illustrates a schematic view of a sintering assembly in accordance with embodiments of the disclosure;

FIGS. 2A-2F illustrate process steps of forming a densified structure through a sintering process in accordance with embodiments of the disclosure;

FIG. 3A illustrates a porous preform structure in accordance with embodiments of the disclosure;

FIG. 3B illustrates a densified structure formed from the porous preform structure of FIG. 3A;

FIG. 4A illustrates a porous preform structure in accordance with embodiments of the disclosure;

FIG. 4B illustrates a densified structure formed from the porous preform structure of FIG. 4A;

FIG. 5 illustrates a diagram of a system for forming a densified structure in accordance with embodiments of the disclosure; and

FIG. 6 illustrates a flow chart representative of a method of forming a densified structure in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the claims. The drawings are not necessarily to scale. Additionally, elements common between figures may retain the same numerical designation.

In addition, it is noted that the embodiments may be described in terms of a process that is depicted as method acts, a flowchart, a flow diagram, a schematic diagram, a block diagram, a function, a procedure, a subroutine, a subprogram, and the like. Although the process may describe operational acts in a particular sequence, it is to be understood that some or all of such acts may be performed in a different sequence. In certain circumstances, the acts are performed concurrently with other acts.

The terms used in describing the various embodiments of the disclosure are for the purpose of describing particular embodiments and are not intended to limit the disclosure. As used herein, the singular forms are intended to include the plural forms as well, unless the context clearly indicates otherwise. All of the terms used herein including technical or scientific terms have the same meanings as those generally understood by a person of ordinary skill in the art unless they are defined otherwise. Terms defined in this disclosure should not be interpreted as excluding the embodiments of the disclosure. Additional term usage is described below to assist the reader in understanding the disclosure.

The terms “have,” “may have,” “include,” and “may include” as used herein indicate the presence of corresponding features (for example, elements such as numerical values, functions, operations, or parts), and do not preclude the presence of additional features.

As used herein, the terms “configured” and “configuration” refers to a size, a shape, a material composition, a material distribution, orientation, and arrangement of at least one feature (e.g., one or more of at least one structure, at least one material, at least one region, at least one device) facilitating use of the at least one feature in a pre-determined way.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “below,” “lower,” “bottom,” “above,” “upper,” “top,” and the like, may be used for ease of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the term “and/or” means and includes any and all combinations of one or more of the associated listed items.

As used herein, the terms “vertical,” “longitudinal,” “horizontal,” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure.

As used herein, the terms “electrical field assisted sintering (EFAS)” and “spark plasma sintering (SPS)” are equivalent terms that may be used interchangeably.

It will be understood that, when two or more elements are described as being “coupled,” “operatively coupled,” “in communication,” or “in operable communication” with or to each other, the connection or communication may be direct, or there may be an intervening element between the two or more elements. To the contrary, it will be understood that when two or more elements are described as being “directly” coupled with or to another element or in “direct communication” with or to another element, there is no intervening element between the first two or more elements.

Furthermore, “connections” or “communication” between elements may be, without limitation, wired, wireless, electrical, mechanical, optical, chemical, electrochemical, comparative, by sensing, or in any other way two or more elements interact, communicate, or acknowledge each other. It will further be appreciated that elements may be “connected” with or to each other, or in “communication” with or to each other by way of local or remote processes, local or remote devices or systems, distributed devices, or systems, or across local or area networks, telecommunication networks, the Internet, other data communication networks conforming to a variety of protocols, or combinations of any of these. Thus, by way of non-limiting example, units, components, modules, elements, devices, and the like may be “connected,” or “communicate” with each other locally or remotely by means of a coaxial cable, fiber optic cable, twisted pair, digital subscriber line (DSL), shared chipset or wireless technologies such as infrared, radio, and microwave.

As discussed above, sintering technologies, such as electric field assist sintering (EFAS), hot isostatic pressing, hot pressing, etc., are used to manufacture structures from advanced materials. Conventional sintering processes are not typically used for forming complex shapes. Forming complex shapes to a near net shape through a sintering process may facilitate using advanced materials in additional applications and may facilitate improvements in many technologies that operate in harsh environments. Embodiments of the disclosure may facilitate forming near net shape structures having a complex geometry though a sintering process.

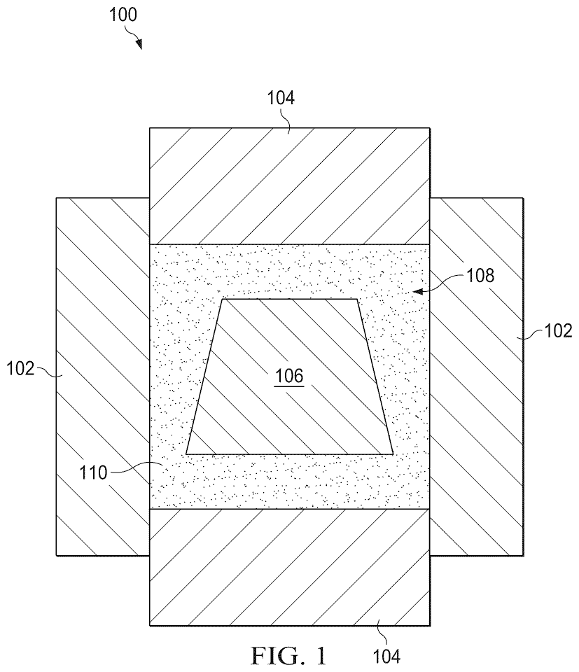

FIG. 1 illustrates a sintering assembly 100 that may be used to form a structure through a sintering process. The structure may exhibit a complex geometry. The sintering assembly 100 may be a conventional sintering assembly configured to heat a base material 106 while applying a pressure to the base material 106 to form a solid structure. The base material 106 may, for example, be formed by additive manufacturing process, such as 3D printing techniques. By way of example only, the base material 106 may be formed by ceramic 3D binder jet printing (3DBJP) or laser powder bed fusion (LPBF). In some embodiments, the sintering assembly 100 is an electric field assist sintering (EFAS) assembly configured to apply a pressure to a material while heating the material and sintering assembly 100 by passing an electric current through the sintering assembly 100 and the material. In other embodiments, the sintering assembly 100 may be a hot press sintering assembly where the sintering assembly is heated externally, such as through inductive heating, resistance heating, etc.

The sintering assembly 100 includes a mold 102 defining a cavity 108 within the mold 102 configured to receive the base material 106 to be sintered. The sintering assembly 100 also includes one or more rams 104 configured to apply pressure to the material in the cavity 108 of the mold 102. In the embodiment illustrated in FIG. 1, the sintering assembly 100 includes two opposing rams 104 positioned on opposing sides of the mold 102 and configured to apply a pressure to the base material 106 in the cavity 108 defined in the mold 102 and between the two rams 104. In an EFAS assembly, a voltage is applied between the two rams 104 to induce an electric current from the first ram 104, through the mold 102 and the materials in the cavity 108, and out the second ram 104. The electrical current passing through the mold 102 and the base material 106 in the cavity 108 generates heat in the mold 102 and the base material 106 in the cavity 108 based on the resistance of the material of the mold 102 and the base material 106 in the cavity 108 to the electrical current.

In a conventional sintering process the base material 106 to be sintered is disposed in the cavity 108 in a powdered or granulated form. A pressure is then applied to the cavity 108 through the rams 104 and a temperature of the mold 102 is raised to a sintering temperature of the base material 106 within the cavity 108. The sintering temperature is less than the melting temperature of the material but sufficiently high that the individual particles in the powdered or granulated material fuse together under pressure to form a solid structure.

In some embodiments, a pressure transfer material 110 may be disposed in the cavity 108 surrounding the base material 106 and filling any voids within the cavity 108. For example, the base material 106 may be formed as a so-called porous “green” structure having a shape similar to the desired final shape of the part. The pressure transfer material 110 may be configured to fill in the cavity 108 around the porous part, forming a pseudo mold around the base material 106 to maintain the shape of the base material 106 within the cavity 108. The pressure transfer material 110 may be configured to transfer the pressure applied by the rams 104 to the base material 106, such that the base material 106 may be subsequently sintered to form a solid, densified part (e.g., a fully dense structure, a partially dense structure, a structure having a greater density than the porous “green” structure). Using a porous structure and the pressure transfer material 110 may facilitate sintering complex geometries that may not be easily sintered through conventional methods.

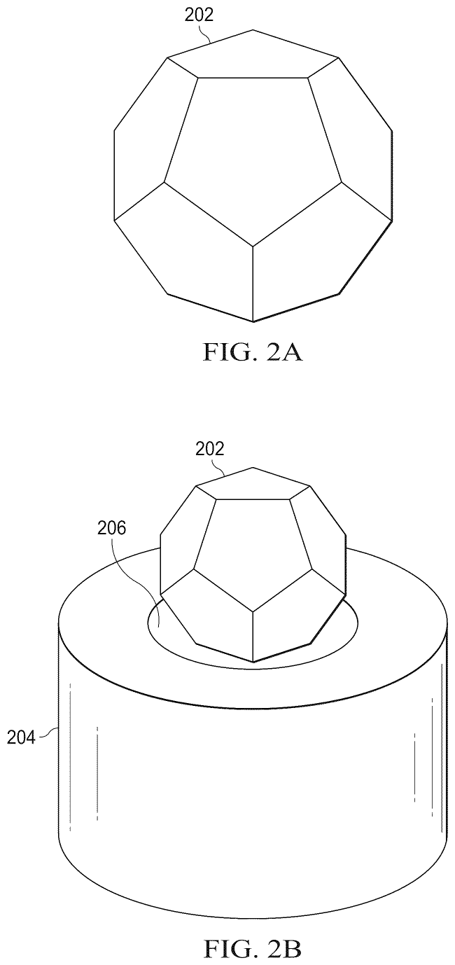

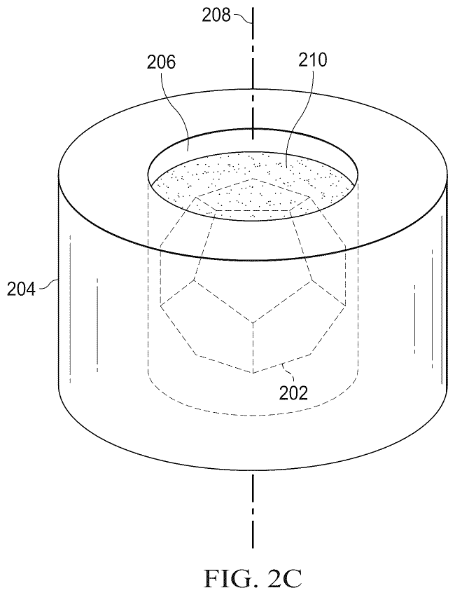

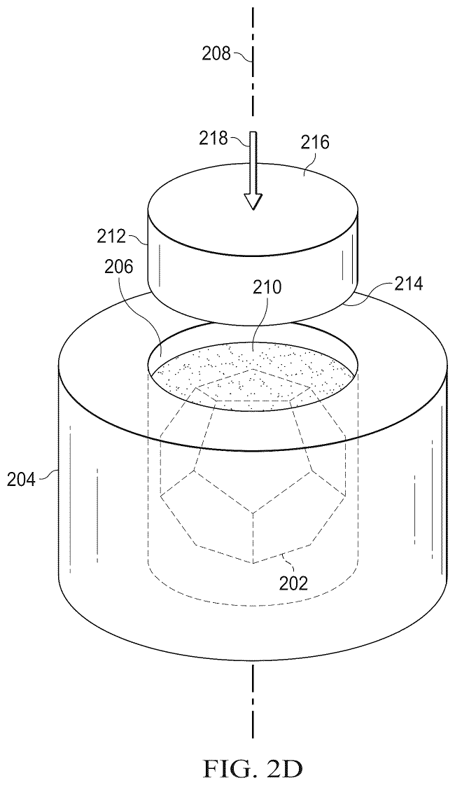

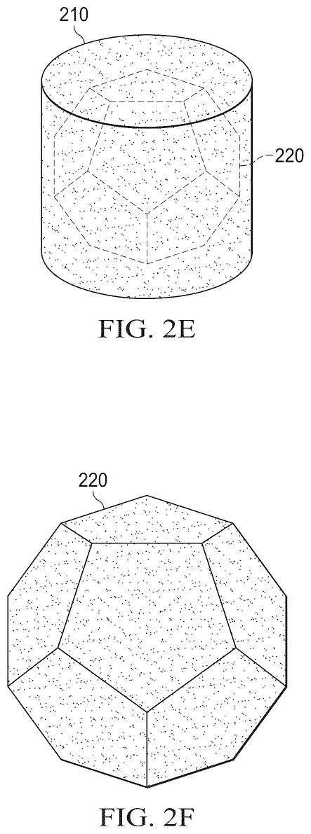

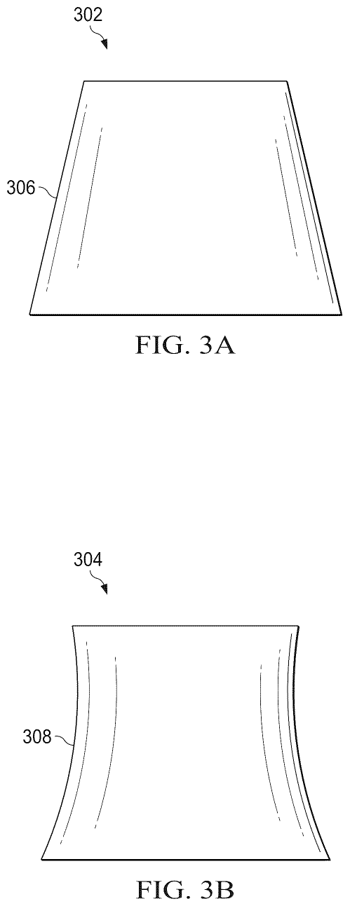

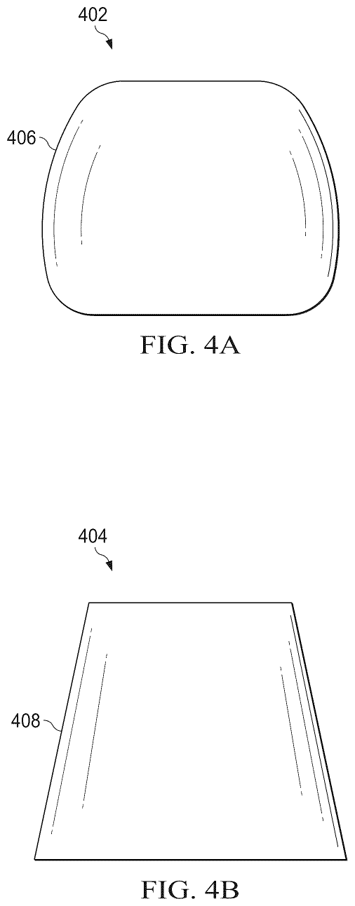

FIGS. 2A-2F illustrate process acts of a process of sintering a structure having complex geometry. In FIG. 2A a porous preform structure 202 is formed. The porous preform structure 202 may be referred to as a “green” structure. In some embodiments, the porous preform structure 202 is formed to have a shape substantially the same as the desired final near net shape of the densified structure. In other embodiments, the porous preform structure 202 may be shaped to accommodate geometric shape changes that occur during the subsequent sintering process. The process of determining the shape of the porous preform structure 202 is discussed in further detail below with respect to FIGS. 3A-4B. The porous preform structure 202 may be formed from a ceramic (e.g., tungsten carbide, tungsten tetraboride, zirconium dioxide, aluminum oxide, yttria stabilized zirconia, etc.), a cermet (e.g., titanium carbonitride, chromium carbide-nickel chromium, tungsten-cerium oxide, zirconia-stainless steel, etc.), a refractory material, or a powder metallurgy metal and alloy (e.g., stainless steel, titanium, copper, etc.).

The porous preform structure 202 may be formed through an additive manufacturing process, such as ceramic 3D binder jet printing (3DBJP) and selective laser sintering (SLS), such as laser powder bed fusion (LPBF), or a casting process, such as slip casting, sand casting, centrifugal casting, permanent mold casting, etc. The additive manufacturing process and/or casting process may facilitate forming the porous preform structure 202 to have complex shapes, cavities, voids, spaces, recesses, protrusions, etc. For example, in the embodiment illustrated in FIG. 2A, the porous preform structure 202 is a dodecahedron. In other embodiments, the porous preform structure 202 may be a sphere, pyramid, star, turbine, turbine blade, impeller, fluid flow component with complex inner channels, etc.

After the porous preform structure 202 is formed, the porous preform structure 202 is disposed into a cavity 206 of a mold 204, such as the mold 102 of the sintering assembly 100 illustrate in FIG. 1. The mold 204 defines the cavity 206 having a relatively simple geometry shape, such as a cylinder. In the embodiment illustrated in FIG. 2B, the mold 204 defines a cylindrical cavity 206 having a circular cross-section. As illustrated in FIG. 2B, the cavity 206 of the mold 204 does not have the same shape as the porous preform structure 202. The mold 204 may be selected to have a cavity 206 having similar dimensions to the largest major dimension of the porous preform structure 202, such that a remaining void within the cavity 206 after the porous preform structure 202 is disposed into the cavity 206 is relatively small.

After the porous preform structure 202 is disposed into the cavity 206, a pressure transfer material 210 is disposed into the cavity 206, filling the remaining void within the cavity 206 around the porous preform structure 202 as illustrated in FIG. 2C. The pressure transfer material 210 may be formulated and configured to transfer pressure and heat to the porous preform structure 202 during the sintering process while being easily removable after the sintering process.

The pressure transfer material 210 is selected to have a melting temperature higher than the sintering temperatures used during the sintering process, such that the volume of the pressure transfer material 210 remains substantially the same. For example, the pressure transfer material 210 may be a powder material having a sintering temperature that is higher than the sintering temperature of the material of the porous preform structure 202, such that after the sintering process the pressure transfer material 210 remains a powder and can be removed (e.g., washed off) the resulting structure. In some embodiments, the pressure transfer material 210 is calcium oxide or silicon dioxide, which are at least partially soluble in (e.g., dissolvable in) water or acid solutions and have high melting and sintering temperatures, such as sintering temperatures in a range from about 1000° C. to about 2000° C. The pressure transfer material 210 may also be selected as a material with minimal reactivity to the material of the porous preform structure 202, such that it can be easily removed via chemical dissolution or mechanical methods after the sintering process is completed. In some embodiments, the pressure transfer material 210 is a mixture of dissolvable and non-dissolvable powders, where the pressure transfer material 210 is configured to be exposed to an acid or other solvent configured to dissolve the dissolvable powder and mechanically remove the remaining non-dissolvable powder through a process, such as sonication. For example, the pressure transfer material 210 may include dissolvable materials such as calcium oxide or strontium carbonate (SrCO₃) combined with non-dissolvable materials such as graphite powder, silicon carbide (SiC) or boron carbide (B₄C) powders.

After the remaining voids in the cavity 206 of the mold 204 are filled with the pressure transfer material 210, a ram 212 is used to apply a pressure to the pressure transfer material 210 and the porous preform structure 202 in the cavity 206 as illustrated in FIG. 2D. The ram 212 is disposed into the cavity 206, such that an inner surface 214 of the ram 212 contacts the pressure transfer material 210 and any exposed portions of the porous preform structure 202 in the cavity 206 of the mold 204. A force 218 is applied to an outer surface 216 of the ram 212 in an axial direction parallel to an axis 208 of the mold 204. The force 218 applied to the ram 212 increases a pressure on the pressure transfer material 210 and the porous preform structure 202 within the cavity 206 of the mold 204. Dimensions of the ram 212 may be substantially the same as dimensions of the cavity 206.

As discussed above, the porous preform structure 202 may be heated while under the pressure applied by the ram 212. In some embodiments, the sintering assembly is an EFAS system such as the sintering assembly 100 discussed above with respect to FIG. 1. In an EFAS system, the porous preform structure 202 is heated by an electrical current passing through the ram 212, the mold 204, the pressure transfer material 210, and the porous preform structure 202. In other embodiments, the mold 204 may be heated externally.

The pressure applied by the ram 212 is maintained and the elevated temperature is maintained for a designated time period to produce a densified structure 220. The pressure, temperature, and the time period may be selected based on the material of the porous preform structure 202 and the material of the pressure transfer material 210. For example, the temperature and pressure may be selected to be within the sintering temperature and pressure ranges for the porous preform structure 202 while being at or below at least one of the sintering temperature range and sintering pressure range of the pressure transfer material 210. The temperature may also be selected to be below the melting temperature of the pressure transfer material 210.

After the designated time period is completed, the pressure and elevated temperature may be decreased or released. The pressure transfer material 210 and the densified structure 220 formed from the porous preform structure 202 are then removed from the mold 204 as illustrated in FIGS. 2E and 2F. The densified structure 220 is the sintered structure formed from the porous preform structure 202 after the sintering process. The densified structure 220 may be characterized by coalesced particles, significantly reduced or eliminated porosity relative to the porous preform structure 202, and enhanced mechanical integrity relative to the porous preform structure 202. The densified structure 220 may exhibit a density at or near a maximum theoretical density of the constituent material system, together with the corresponding improvement in strength, hardness, conductivity, or other functional properties.

The densified structure 220 is substantially encapsulated by the pressure transfer material 210. As discussed above, the pressure transfer material 210 may be selected to have a sintering temperature and melting temperature above the sintering temperature range of the material of the densified structure 220. Therefore, the pressure transfer material 210 may remain in a substantially porous non-sintered configuration. This may facilitate the removal of the pressure transfer material 210 from around the densified structure 220. For example, the pressure transfer material 210 may be removed through a washing process using water or other chemicals formulated to remove or dissolve the pressure transfer material 210.

Once the pressure transfer material 210 is removed, the densified structure 220 remains as illustrated in FIG. 2F. The densified structure 220 may be formed in a near net shape, such that the densified structure 220 is substantially formed in the desired final geometric shape.

FIGS. 3A-3B illustrate a porous preform structure 302 and the densified structure 304 resulting from a sintering process, such as the sintering process discussed above, with respect to FIGS. 2A-2F. As the particles in the porous preform structure 302 coalesce during the sintering process, the shape of the porous preform structure 302 may change, such that the resulting densified structure 304 does not exhibit the same shape as the porous preform structure 302. For example, because the porous preform structure 302 is disposed in a pressure transfer material within the cavity of the mold, there may be some variability around the porous preform structure 302 during the sintering process, such that non-uniformity of pressure or temperature within the porous preform structure 302 during the sintering process may result in portions of the porous preform structure 302 decreasing (e.g., shrinking) in one direction more than another direction or decreasing (e.g., shrinking) in one direction and increasing (e.g., growing) in another direction.

In the embodiment illustrated in FIGS. 3A-3B, the porous preform structure 302 has lateral sides 306 that are substantially straight and after the sintering process the densified structure 304 has lateral sides 308 that are curved and concave. Thus, forming the porous preform structure 302 to a near net shape, may not result in the densified structure 304 having a near net shape. To account for the changes in shape during the sintering process, historical data may be used to train a Neural Network Model (NNM) to predict the shape of the porous preform structure 302 that will result in a densified structure 304 having a desired shape that is the near net shape. The historical data may include sintering temperatures, sintering pressures, preform materials, pressure transfer materials, mold materials, ram materials, mold dimensions, preform dimensions, preform arrangement, preform shape, densified structure shape, sintering time period, sintering current for EFAS systems, sintering voltage for EFAS systems, temperature rise rate, pressure rise rate, etc.

FIG. 4A illustrates a porous preform structure 402 that may be formed to accommodate the geometric changes during the sintering process to result in a densified structure 404 having a desired near net shape. The shape of the porous preform structure 402 may be determined based on historical data, such as the porous preform structure 302 and densified structure 304 discussed above, with respect to FIGS. 3A-3B. In the embodiment illustrated in FIG. 4A, the porous preform structure 402 is formed to have lateral sides 406 that are convex, such that after the sintering process, the lateral sides 408 of the densified structure 404 illustrated in FIG. 4B are substantially straight rather than the concave lateral sides 308 of the densified structure 304 illustrated in FIG. 3B. As discussed above, the historical data may be stored and processed with a NNM and the NNM may output the shape of the porous preform structure 402 to reach the desired near net shape of the densified structure 404.

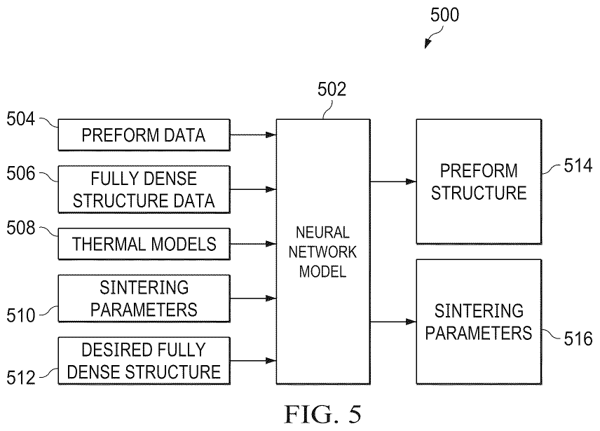

FIG. 5 illustrates a simplified diagram of a system 500 that may be used to determine the shape of a porous preform structure (e.g., porous preform structure 202, 302, 402) to form a near net shape densified structure (e.g., densified structure 220, 304, 404). As discussed above, the system 500 may utilize a neural network model 502 to store and analyze the relevant data. The neural network model 502 may be trained on preform data 504, densified structure data 506, thermal models 508, and sintering parameters 510. The neural network model 502 may be stored in a memory device, such as a non-transitory computer readable medium. The non-transitory computer readable medium may also include instructions configured to control a processor.

The preform data 504 may include the material of the preform, the shape of the preform, the dimensions of the preform, material properties of the preform, the method used to form the preform, etc. In some embodiments, the preform structure is imaged using a surface scanning tool and/or X-ray computed tomography (XCT). The imaging tool may capture geometric dimensionality at multiple points as well as the volumetric density at the multiple points. The data from the imaging tool may also be input into the NNM. As discussed above, the preform may be formed through an additive manufacturing process. Different additive manufacturing processes may result in the preform having different properties, such as different grain orientations, different porosity, different densities, etc.

The densified structure data 506 may include the shape of the densified structure, the dimensions of the densified structure, material properties of the densified structure, etc. The sintered structure may be scanned again via an imaging tool to capture the transformed final state. Digital volume correlation (DVC) may be performed to quantify the exact changes in the densified structure.

The thermal models 508 may be computational models of the sintering system including the mold, the ram(s), the pressure transfer material, and the preform structure. The computational models may be mathematical models predicting the thermal behavior of the different components in the sintering system. The models may provide data, such as the rate of the temperature change at different locations within the preform during the sintering process, the time that different portions of the preform spend at a temperature above the sintering temperature, the effects of different temperatures of the sintering system, the effects of different amperages or voltages used in a EFAS system, the effects of different pressure transfer materials, the effects of different mold materials or dimensions, etc. For example, variables such as mold wall thickness may affect electrothermal Joule heating behavior during a sintering process. In some embodiments, additional data directed to the thermal properties of the system may be included as historical data in addition to the model data.

The sintering parameters 510 may include both historical data and model data. For example, different sintering parameters, such as temperatures, pressures, amperages, voltages, dwell times, temperature change rates, etc., may be used when forming the associated densified structures. In addition, as discussed above, the thermal models 508 may be run using different sintering parameters to see the effects on the thermal distribution within the associated preform structures.

In some embodiments, larger cavities in a mold may be used to form larger densified structures, such as, but not limited to, structures having major dimensions (e.g., diameter, width, length, etc.) greater than about 6 inches (greater than about 15.3 cm), such as having major dimensions in a range from about 6 inches (about 15.3 cm) to about 80 inches (about 203.2 cm), such as from about 10 inches (about 25.4 cm) to about 22 inches (about 55.9 cm). Larger cavities in the mold may facilitate forming densified structures having larger major dimensions. Larger major dimensions result in an increase of the thermal mass of the sintering assembly and the associated preform structure and pressure transfer material. To accommodate the larger thermal mass, the heating rate of the system 500 may be reduced. For example, the temperature of the cavity may be increased at a rate of less than about 50° C./minute, such as in a range from about 1° C./min to about 20° C./min, from about 2° C./min to about 10° C./min, or from about 10° C./min to about 20° C./min. In an EFAS system, the temperature change may be generated through a current passing through the sintering assembly, the pressure transfer material, and the preform structure. The temperature change may be generated with a current density in a range from about 0.5 A/mm² to about 1 A/mm², such as about 0.8 A/mm².

The larger major dimensions may also facilitate the use of lower pressures. For example, a sintering assembly having a major dimension in a range from about 0.5 inches (about 1.27 cm) to about 6 inches (about 15.3 cm) may use pressures in a range from about 40 MPa to about 60 MPa. A sintering assembly having a major dimension in a range from about 10 inches (about 25.4 cm) to about 22 inches (about 55.9 cm) may have similar results at pressures in a range from about 10 MPa to about 20 MPa. The lower pressures may facilitate using a mold with a larger major dimension without significant increases in the forces used to maintain the pressure in the cavity of the mold.

The lower pressure may be facilitated by increasing a dwell time at the sintering temperature. For example, dwell times may increase from about 5 minutes to a range from about 30 minutes to about 90 minutes.

Once the neural network model 502 is trained, a user may input parameters for a desired densified structure 512. The parameters for the desired densified structure 512 may include the material of the desired densified structure 512, the shape of the desired densified structure 512, the dimensions of the desired densified structure 512, etc. The neural network model 502 may then output the properties of a preform structure 514 and the associated sintering parameters 516 to form a densified structure with a near net shape of the desired densified structure 512. For example, the neural network model 502 may compare the desired densified structure 512 to historical densified structure data 506 of a similar densified structure and determine the preform data 504 that was associated with the relevant densified structure data 506. In other example, the neural network model 502 may compare the desired densified structure 512 to the historical densified structure data 506 of multiple at least partially related densified structures and combine the associated preform data 504.

In some embodiments, the parameters for the desired densified structure 512, may be similar to historical data already stored in the neural network model 502. In this case, the neural network model 502 may identify the preform data 504 associated with the densified structure that meets the parameters of the desired densified structure 512 input into the model. In other embodiments, the parameters of the desired densified structure 512 may have differences from the data used to train the neural network model 502. For example, the desired shape of the desired densified structure 512 may be a complex shape, such as a turbine, an impeller, a structure having complex internal passages, etc. The neural network model 502 may combine the parameters from multiple different structures from the historical data to arrive at the parameters for the preform structure 514 and the sintering parameters 516.

In some embodiments, the neural network model 502 is operatively coupled to at least one of a sintering system or an additive manufacturing system. For example, the neural network model 502 may output instructions to the additive manufacturing system to form a preform in accordance with the parameters of the preform structure 514 calculated by the neural network model 502. In another example, the neural network model 502 may control a sintering system to operate at the sintering parameters 516 calculated by the neural network model 502. In other embodiments, the neural network model 502 may output a file, such as a 3-D model of the parameters of the preform structure 514 calculated by the neural network model 502, such that the user may use the file to guide the construction of the associated preform structure.

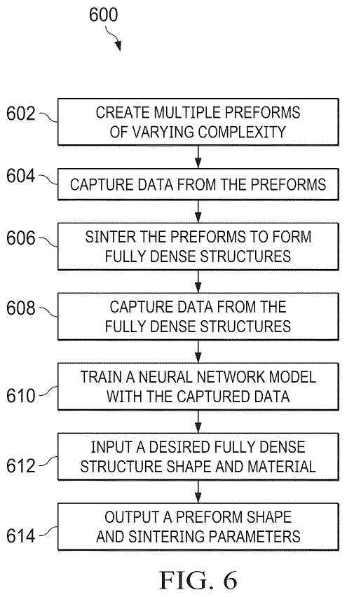

FIG. 6 illustrates a flow chart representative of a method 600 of training a NNM and using the NNM to generate preform parameters. The method 600 involves capturing data from multiple processes to train the NNM and then using the NNM to generate preform parameters.

Multiple preform structures, such as the porous preform structures 202, 302, 402 of FIGS. 2A-4B are created in act 602. The multiple preform structure are formed to exhibit different geometrical shapes and sizes. The geometric shapes may be of varying complexity. For example, the geometric shapes may include cylinders, prisms, spheres, cones, pyramids, octahedrons, dodecahedrons, star shapes, gear shapes, turbines, impellers, etc.

Data is captured from the multiple preform structures in act 604. The data captured may include the material of the preform structures, the shape of the preform structures, the dimensions of the preform structures, material properties of the preform structures, the method used to form the preform structures, etc. In some embodiments, some of the data captured from the preform structure is captured using an imaging tool, such as a surface scanning tool or X-ray computed tomography (XCT). For example, the XCT may capture geometric dimensionality at multiple points as well as the volumetric density at the multiple points.

Each of the multiple preform structures are sintered to form densified structures in act 606. As discussed above, the complex preforms may be disposed in a cavity of a mold. The cavity may then be filled with a pressure transfer material configured to fill in voids in the preform structure and voids between the preform structure and the walls of the mold. The cavity may then be subjected to pressure such as with a ram applying pressure to one or more surfaces of the pressure transfer media and/or the preform structure. The temperature in the cavity of the mold may also be increased to a sintering temperature of the materials of the preform structure. As discussed above, the temperature in the cavity may be increased through multiple different methods depending on the sintering process being employed. For example, in an EFAS system, the temperature in the cavity is increased by passing an electrical current through the mold, the pressure transfer material, and the preform structure. In other embodiments, the temperature in the cavity may be increased by heating the mold externally.

As discussed above, data regarding the sintering process may also be captured, such as the type of sintering process, the size of the components of the sintering assembly (e.g., the rams, the mold, the cavity, etc.), the material of the components of the sintering assembly, the sintering temperature, the pressure, the rate of change of the temperature and pressure, the dwell time at the sintering temperature and pressure, etc.

After the densified structures are formed, data may be captured from the densified structures in act 608. The data captured from the densified structures may include the shape of the densified structure, the dimensions of the densified structure, material properties of the densified structure, etc. The sintered structure may be scanned again via the imaging tool to capture the transformed final state. Digital volume correlation (DVC) may be performed to quantify the exact changes in the densified structure.

A neural network model (NNM) may then be trained with the captured data in act 610. The captured data from acts 604, 608 may be aggregated, filtered, normalized, labeled, or otherwise preprocessed and used to train the NNM. The NNM may be configured to identify patterns, classify conditions, predict outcomes, or generate control outputs associated with the process or apparatus. The training may be performed using supervised, unsupervised, semi-supervised, or reinforcement-learning techniques, and may include iteratively adjusting model parameters based on a loss function to improve correspondence between model outputs and reference data.

Once the NNM is trained, the user may input a desired shape of a densified structure and the desired material of the densified material into the NNM in act 612. Based on the data used to train the NNM, the NNM may then output a preform shape and the associated sintering parameters that will result in a densified structure have a near net shape that is approximately the same as the desired shape in act 614.

The embodiments of the disclosure may facilitate the formation of complex, near net shape structures through sintering processes. The advanced materials formed through sintering processes may be difficult to machine, such that it may be difficult to change the shape of a densified structure after it is formed. Forming the structure into a near net shape may minimize or eliminate the need to do any post forming machining. The embodiments of the disclosure may also facilitate forming complex shapes and accommodating the changes in the shape that may occur within a mold filled with pressure transfer material that may not hold or maintain a specific shape. Forming complex near net shape structures may facilitate the use of advanced materials in many different devices that may operate in harsh environments, which may increase an efficiency and/or operational life of the associated devices.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A method of forming a densified structure, the method comprising:
forming a preform structure;
disposing the preform structure into a cavity of a mold;
disposing a pressure transfer material into the cavity of the mold around the preform structure;
applying a pressure to the cavity of the mold;
increasing a temperature in the cavity of the mold to a temperature above a sintering temperature of the preform structure and below a sintering temperature of the pressure transfer material until the preform structure becomes a densified structure; and
removing the pressure transfer material from around the densified structure.

2. The method of claim 1, wherein forming the preform structure comprises forming the preform structure through an additive manufacturing process.

3. The method of claim 1, wherein disposing the preform structure into the cavity of the mold comprises disposing the preform structure into the cavity of the mold, the cavity having a major dimension greater than about 10 inches (25.4 cm).

4. The method of claim 3, wherein applying the pressure to the cavity having the major dimension greater than about 10 inches (25.4 cm) comprises applying a pressure in a range from about 10 MPa to about 20 MPa.

5. The method of claim 3, wherein increasing the temperature in the cavity having the major dimension greater than about 10 inches (25.4 cm) comprises increasing the temperature at a rate in a range of about 1° C./min to about 20° C./min.

6. The method of claim 3, further comprising maintaining the temperature in the cavity having the major dimension greater than about 10 inches (25.4 cm) at the temperature above the sintering temperature of the preform structure and below the sintering temperature of the pressure transfer material for a dwell time in a range from about 30 minutes to about 90 minutes.

7. A system for forming a densified structure, the system comprising:
a processor;
a memory device storing historical data representative of preform structures and densified structures; and
non-transitory computer readable medium storing instructions thereon that, when executed by at the processor, cause the processor to perform steps comprising:
receive parameters of a desired densified structure;
compare the historical data representative of the preform structures and the densified structures with the parameters of the desired densified structure; and
output parameters of a preform structure.

8. The system of claim 7, wherein the instructions cause the processor to:
train a neural network model with the historical data representative of the preform structures and the densified structures; and
compare the historical data representative of the preform structures and the densified structures with the parameters of the desired densified structure through the neural network model.

9. The system of claim 7, wherein the historical data includes preform data, densified structure data, thermal models, and sintering parameters.

10. The system of claim 9, wherein at least some of the preform data and the densified structure data is captured through X-ray computed tomography.

11. The system of claim 9, wherein the preform data and the densified structure data comprise data from multiple different geometries of preforms and densified structures.

12. The system of claim 7, wherein the instructions cause the processor to output the parameters of the preform structure to an additive manufacturing device.

13. The system of claim 7, wherein the instructions cause the processor to output sintering parameters for forming the desired densified structure.

14. The system of claim 13, wherein the sintering parameters comprise a sintering temperature and a sintering pressure.

15. The system of claim 13, wherein the instructions cause the processor to output the sintering parameters to a sintering assembly.

16. The system of claim 7, wherein the instructions cause the processor to output the parameters of the preform structure and the parameters of the preform structure define a different shape than the parameters of the desired densified structure.

17. A method of forming a densified structure comprising:
receiving parameters of a desired densified structure;
comparing historical data representative of preform structures and densified structures with the parameters of the desired densified structure;
providing parameters of a preform structure;
forming, with an additive manufacturing device, the preform structure according to the parameters of the preform structure; and
forming, with a sintering assembly, the desired densified structure from the preform structure.

18. The method of claim 17, wherein comparing historical data representative of the preform structures and the densified structures with the parameters of the desired densified structure comprises:
training a neural network model with the historical data representative of the preform structures and the densified structures; and
comparing the historical data representative of the preform structures and the densified structures with the parameters of the desired densified structure through the neural network model.

19. The method of claim 17, wherein providing parameters of the preform structure comprises providing parameters of the preform structure including a preform structure shape, wherein the preform structure shape is different from a desired shape of the desired densified structure.

20. The method of claim 17, wherein comparing the historical data representative of the preform structures and the densified structures with the parameters of the desired densified structure comprises comparing historical data representative of multiple preform structures having multiple different shapes and associated densified structures having multiple different shapes with the parameters of the desired densified structure.
